(19) United States
(12) Patent Application Publication
(10) Pub. No.: US 2014/0318018 A1
(43) Pub. Date: Oct. 30, 2014

(54) MECHANICAL SWING GATE

(71) Applicant: Team Excel Development Limited, Shanghai (CN)

(72) Inventor: Tyler Huang, Shanghai (CN)

(21) Appl. No.: 14/260,649

(22) Filed: Apr. 24, 2014

(30) Foreign Application Priority Data
Apr. 25, 2013 (GB) 1307434.9

(51) Int. Cl. E05F 1/10; E05C 3/12; E06B 11/02

(52) U.S. Cl. CPC E05F 1/10; E06B 11/025; E05C 3/12
USPC 49/386; 49/506

(57) ABSTRACT

A gate assembly is provided for positioning in an opening through which selective entry is required. The gate assembly includes barrier means mountable directly or indirectly to one or more surrounding surfaces defining said opening, and hinge means to allow said barrier means to be movable relative to said surrounding surfaces in use between a closed condition, wherein the opening is closed, to an open condition, wherein the opening is open. The hinge means are arranged so that the barrier means and/or hinge means has an axis of pivot which is at an acute angle to a vertical axis. Resilient biasing means are associated with the hinge means to help bias the barrier means from the open condition to the closed condition in use. The resilient biasing means act in a direction along a substantially horizontal axis or along an axis substantially transverse or perpendicular to the axis of pivot of the barrier means and/or hinge means.

This invention relates to a gate assembly and to a method of use thereof.

Although the following description refers almost exclusively to a gate assembly in the form of a child safety gate or barrier, for use in preventing access of a child through an opening when the gate is in a closed position, it will be appreciated by persons skilled in the art that the gate assembly of the present invention could be any type of barrier system used for any purpose.

It is known to provide child safety barriers which are removably located in an opening of a doorway, stairway and/or the like to prevent a child or animal from going through the opening when the barrier is in a closed position. The barriers typically include a frame which is fitted to side walls defining the opening, and a gate or barrier which is hingedly or slidably mounted to the frame for movement between open and closed positions. A problem with such child safety barriers is that a user can accidentally leave the barrier open, thereby allowing the child or animal to pass through the opening unsupervised.

In order to overcome the abovementioned problem, it is known to provide automatic closure mechanisms for gates, such that as soon as a user releases their grip on the gate, the gate automatically moves from an open position to a closed position. For example, some automatic gate closure mechanisms include sprung hinges. The automatic closure mechanisms have to be designed so that a small child or animal cannot accidentally trap a body part therein as the gate moves to the closed position.

It is now a safety requirement in some countries for an automatic closure mechanism on a gate to be able to activate closure of the gate from a minimum of a 1 degree opening position (i.e. one degree relative to a substantially horizontal axis/closed gate position). Most conventional gates only activate automatic closure of the gate from a minimum of a 3-5 degrees opening position (i.e. three-five degrees relative to a substantially horizontal axis/closed gate position).

US2012/0055092 discloses a child safety gate hingedly attached to a frame via upper and lower hinges. The hinges are arranged such that the pivotal axis of the upper and lower hinges is offset to the vertical. This allows the gate to pivot back to a closed position, once opened, by means of gravitation. A spring provided between the two halves of each swivel hinge also allows the gate to return to a closed position from an open position. The axis of movement of the spring is substantially parallel to the pivot axis of the gate. The gate needs to be lifted in the direction of the pivot axis in order to move the gate to an open position.

It is therefore an aim of the present invention to provide a gate assembly with an improved automatic closure mechanism.

It is a further aim of the present invention to provide a method of using a gate assembly having an improved automatic closure mechanism.

It is a yet further aim of the present invention to provide an automatic closure mechanism for a gate assembly.

It is a yet further aim of the present invention to provide a gate assembly with an improved handle mechanism.

It is a yet further aim of the present invention to provide a method of using a gate assembly with an improved handle mechanism.

It is a yet further aim of the present invention to provide a handle mechanism for use on a gate assembly.

According to a first aspect of the present invention there is provided a gate assembly for positioning in an opening through which selective entry is required, said gate assembly including barrier means mountable directly or indirectly to one or more surrounding surfaces defining said opening and hinge means to allow said barrier means to be movable relative to said surrounding surfaces in use between a closed condition, wherein the opening is closed, to an open condition, wherein the opening is open, said hinge means arranged so that the barrier means and/or hinge means have an axis of pivot which is at an acute angle to the vertical, resilient biasing means associated with the hinge means to help bias the barrier means from the open condition to the closed condition in use, characterised in that the resilient biasing means act in a direction along a substantially horizontal axis or along an axis substantially transverse or perpendicular to the axis of pivot of the barrier means and/or hinge means.

Thus, the present invention provides an automatic closure mechanism for a gate assembly comprising a pivot axis of the barrier means and/or hinge means which is inclined or at an acute angle to the vertical. This allows the barrier means to at least partly move from an open position to a closed position under gravitational force, typically as a result of a first end of the barrier means being slightly raised with respect to a rear end of the barrier means when in an open position. In addition, the resilient biasing means further helps to bias the barrier means from the open position to the closed position in use. Once a user releases their grip on the barrier means in use, the barrier means typically automatically moves from an open position to a closed position.

The combination of these two features allows automatic closure of the gate even when the barrier means is at an opening position, even when open by a gap as small as 1 degree (i.e. open one degree with respect to a horizontal axis/closed gate position).

Preferably the hinge means includes an upper hinge arrangement provided at, adjacent or towards a top of the barrier means, and a lower hinge arrangement provided at, adjacent or towards a base of the barrier means, the axis of pivot of the upper and lower hinge arrangements being at an acute angle to the vertical.

Preferably the upper and lower hinge arrangements are offset from or substantially out of vertical alignment from each other. By providing the upper and lower hinge arrangements in an offset or non-aligned manner, the barrier means is typically automatically movable from an open position to a closed position even when the barrier means is at an opening position of 1 degree. In many conventional gate assemblies, the upper and lower hinge arrangements are typically co-axial or aligned (i.e. the pivot axes of the upper and lower hinge arrangement are aligned or co-axial). This typically prevents such gate assemblies from automatically closing when the barrier means is at an opening position of 1 degree with respect to a horizontal axis or closed gate position.

Preferably the pivotal axes of the upper and lower hinge arrangement are co-axial.

In one embodiment pivotal axes of each of the upper and lower hinge arrangements can be an upright axis, a substantially vertical axis or at an axis inclined to the vertical (i.e. at an acute angle to the vertical).

Preferably the upper and lower hinge arrangements are provided a spaced distance apart along a horizontal axis. This, at least in part, provides the inclined pivotal axis of the barrier means and/or hinge means. The inclination of the actual pivot pins of the hinge arrangements can, in one embodiment, also contribute to the inclined pivotal axis of the barrier means and/or hinge means.

Preferably the lower hinge arrangement is provided closer to a wall adjacent the hinge arrangements in use compared to the upper hinge arrangement.

Preferably, with the upper and lower hinge arrangements (or the pivotal axes of the upper and lower hinge arrangements) provided in an offset or non-aligned position, an end of the barrier means forms an acute angle with a substantially vertical axis when the barrier means is in an open position. The end is preferably the end joined directly or indirectly to a side wall of the opening via the hinge arrangements.

In one embodiment, if an imaginary line is drawn through the pivot points or axes of the upper and lower hinge arrangements, this line forms an acute angle with a substantially vertical axis in both the open and closed positions.

Preferably the acute angle formed in either of the abovementioned embodiments is an angle between 1-10 degrees to an upright or substantially vertical axis.

Preferably each of the pivotal axes of the upper and lower hinge arrangements is provided at an acute angle to the vertical, and further preferably the same acute angle to the vertical.

In a preferred embodiment the resilient biasing means is provided with or associated with at least the upper hinge arrangement.

Preferably the resilient biasing means includes any or any combination of a spring, sprung material and/or the like.

Preferably the resilient biasing means includes or is associated with or joined to an intermediate member, which in turn is directly or indirectly associated with or engaged with the barrier means.

In one embodiment the resilient biasing means and/or intermediate member is provided with or associated with a frame element or wall to which the hinge means or at least upper hinge arrangement is pivotably mounted to in use.

In one embodiment one end (second end) of the intermediate member is joined to the resilient biasing means and one end (first end) of the intermediate member engages with the barrier means, hinge means or upper hinge arrangement, and further preferably engages in a slot, channel or recess defined on the barrier means, hinge means or upper hinge arrangement.

In one embodiment the intermediate member is slidably mounted in a housing. The housing can be integrally formed or attached to the frame of the gate assembly or to a wall to which the gate assembly is joined to in use.

Preferably the intermediate member acts like a piston in slidably moving in the housing.

Preferably an end of the intermediate member that engages with the barrier means or a slot, channel or recess defined on the barrier means, hinge means or upper hinge arrangement has a curved, bevelled, angled, chamfered, cam surface and/or the like. The shape is such that as the end of the intermediate member moves relative to the barrier means, the biasing force of or acting on the intermediate member moves the barrier means to a fully closed position.

Preferably the slot, channel or recess defined on the barrier means, hinge means or upper hinge arrangement is substantially complementary in shape to the end of the intermediate member that engages therewith in use.

Pivotal movement of the barrier means typically imparts sliding motion of the intermediate member within the housing, and preferably sliding horizontal or transverse movement with respect to the inclined pivotal axis. This movement typically causes the resilient biasing means to be moved between a relatively compressed position to a relatively tensioned position.

In one embodiment the intermediate member is pushed inwardly of the housing as the barrier means is moved from a closed position to an open position in use. The intermediate is moved outwardly of the housing as the barrier means is moved from the open position to the closed position.

Preferably the resilient biasing means biases the intermediate member outwardly of the housing in use towards the recess, slot or channel into which it engages.

Preferably the resilient biasing means is moved from a relatively tensioned position to a relatively compressed position as the barrier means moves from a closed position to an open position in use.

Preferably the resilient biasing means biases the intermediate member towards the barrier means and pivotal movement of the barrier means in use causes sliding movement of the intermediate member against a biasing force of the resilient biasing means.

Preferably the upper hinge means includes a first hinge element including a pivot pin or protrusion member which pivotally or rotatably moves in a recess, channel or aperture provided on a second hinge element in which the pivot pin or protrusion member is located in.

The intermediate member can engage with the first or second hinge element as required. Preferably the intermediate member engages with the first hinge element.

Preferably the first hinge element includes the recess, slot or channel into which and end of the intermediate member locates in use. Further preferably the intermediate member recess, slot or channel is provided on an outer surface of the first hinge element.

In one embodiment the first hinge element is provided on or associated with the barrier means and the second hinge element is provided on or associated with the frame to which the barrier means is pivotally attached to in use or to a wall with respect to which the barrier means pivots in use.

In one embodiment the intermediate member housing is provided on, associated with or integrally formed with the second hinge element.

Preferably the lower hinge arrangement includes a pivot pin or protrusion member on a first hinge portion that is rotatably or pivotally mounted in a recess, channel or aperture provided on a second hinge portion.

In one embodiment the gate assembly includes frame means and the barrier means is pivotably mounted on the frame means via the upper and lower hinge arrangements. The frame means are typically mounted to, located with or abut with the surrounding surfaces or side walls defining the opening in which the gate assembly is to be located in use.

Preferably the frame means are arranged such that barrier means is substantially planar or in alignment with the frame means when in the closed position, and the barrier means is moved out of the plane of the frame means or moved out of alignment with the frame means when moved to the open position.

With the barrier means in a closed position, access through the opening is substantially prevented. With the barrier means in an open position, access through the opening is allowed.

The frame means typically includes at least one upright frame member adjacent the hinge means or upper and lower hinge arrangements, to which at least part of the hinge means or upper and lower hinge arrangements are directly or indirectly attached.

Preferably the lower hinge arrangement is provided closer to the at least one upright frame member than the upper hinge arrangement. Preferably an end of the barrier means forms an angle of 1-10 degrees with the upright frame member when in the open position.

Preferably the upper and/or lower hinge arrangements are pivotably mounted for pivotal movement about a substantially vertical axis.

According to a second aspect of the present invention there is provided a handle mechanism for a gate assembly, said handle mechanism including latch means movable with respect to latch receiving means between a latched position, wherein the latch means is engaged with or located in the latch receiving means, and an unlatched position, wherein the latch means is disengaged from or removed from the latch receiving means, and user actuation means for allowing a user to actuate said latch means in use, and wherein actuation of said user actuation means enables said latch means to undergo movement on movement of the handle mechanism relative to the latch receiving means.

Thus, in accordance with the present invention, actuation of the user actuation means, enables or frees the latch means to undergo movement on further movement of the handle mechanism/barrier means/gate assembly relative to the latch receiving means. This is in contrast to prior art handle mechanisms wherein the latch means typically remains in a fixed position once actuated and/or on movement of the handle mechanism/barrier means/gate assembly relative to the latch receiving means. Movement of the latch means on further movement of the handle mechanism/barrier means/gate assembly relative to the latch receiving means helps the barrier to automatically shut from an open position as small as a one degree open position.

The latch means can undergo slidable, rotational and/or pivotal movement on movement of the handle mechanism/barrier means/gate assembly relative to the latch receiving means during actuation of the user actuation means.

In a preferred embodiment the latch means is arranged to undergo rotational and/or pivotal movement on movement of the handle mechanism/barrier means/gate assembly relative to the latch receiving means.

Preferably the latch means is arranged to undergo rotational and/or pivotal movement about a substantially vertical axis on movement of the handle mechanism/barrier means/gate assembly relative to the latch receiving means.

Preferably locking means are associated with the latch means and actuation of the user actuation means moves the locking means from a locked position, wherein movement of the latch means is substantially prevented, to an unlocked position, wherein movement of the latch means is enabled.

Preferably resilient biasing means are provided on or associated with the locking means for biasing said locking means to a locked position.

The resilient biasing means can include a spring, sprung material and/or the like.

In one embodiment the locking means is slidably moved from the locked position to the unlocked position on actuation of the user actuation means.

Preferably the locking means is movable along a substantially horizontal axis or on an axis substantially transverse to the pivotal axis of the latch means.

Preferably at least one protrusion member provided on one of the locking means or latch means engages in at least one complementary recess, slot or aperture on the other of the locking means or latch means to form the locked position.

Preferably at least two protrusion members are provided on the locking means or latch means.

Preferably the at least one protrusion member is provided on the latch means and the at least one recess, slot or aperture is provided on the locking means.

In one embodiment the latch means has at least one protrusion member provided on an upper surface and a lower surface thereof for engagement in at least one complementary recess, slot or aperture provided on an upper surface and a lower surface of the locking means.

Preferably two user actuation means (first and second user actuation means) are provided on or associated with the handle mechanism and each user actuation means has to be actuated substantially simultaneously in order to actuate the locking means and/or latch means.

In one embodiment actuation of the first user actuation means slidably moves the locking means from the locked position to the unlocked position.

Preferably the first user actuation means is in the form of a trigger member.

Preferably the trigger member and/or first user actuation means has a cam, angled or tapered surface and movement of said surface relative to the locking means causes said locking means to be slidably moved from the locked positon to the unlocked position.

Preferably depression of the trigger member and/or first user actuation means or application of user force thereto inwardly of the handle mechanism housing actuates the trigger member and/or first user actuation means.

In one embodiment actuation of the second user actuation means moves a stop member out of engagement with the locking means, thereby allowing the locking means to be slidably moved by the first user actuation means from the locked position to the unlocked position.

Preferably the second actuation means is in the form of a button.

Preferably depression of the button and/or second actuation means or application of force thereto inwardly of the handle mechanism housing actuates the second user actuation means.

In one embodiment the second user actuation means is pivotably mounted and actuation of the same pivots the second user actuation means which causes said stop member to move from an engaged position to a disengaged position with respect to the locking means.

Preferably the stop member is pivotably mounted and movement of the second user actuation means pivotably moves the stop member from the engaged position to the disengaged position with respect to the locking means.

Preferably resilient biasing means are provided on or associated directly or indirectly with the user actuation means, first and/or second user actuation means to bias the same from an actuated position to an unactuated position.

Preferably one of the latch means and the latch receiving means includes a protrusion portion which engages in a recess, aperture or slot provided on the other of the latch means or latch receiving means when in a latched position. Preferably the protrusion portion is moved a spaced distance apart from the recess, aperture or slot when in the unlatched position.

Preferably the latch means is provided on or associated with the barrier means of a gate assembly and the latch receiving means is provided on or associated with a frame or wall relative to which the barrier means moves in use.

It will be appreciated that the handle mechanism and the hinge mechanism can be used independently of each other or in combination with each other on a gate assembly.

Preferably when the handle mechanism and hinge mechanism are used together, this increases the ease by which an autoclose mechanism can be actuated when the barrier means is in a one degree open position.

According to one aspect of the present invention there is provided a method of using a handle mechanism for a gate assembly, said handle mechanism including latch means, said method including actuating said latch means using user actuation means to move the latch means with respect to latch receiving means between a latched position, wherein the latch means is engaged with or located in the latch receiving means, and an unlatched position, wherein the latch means is disengaged from or removed from the latch receiving means, and wherein actuation of said user actuation means enables said latch means to undergo movement on movement of the handle mechanism relative to the latch receiving means.

According to one aspect of the present invention there is provided a method of using a gate assembly for positioning in an opening through which selective entry is required, said gate assembly including barrier means mountable directly or indirectly to one or more surrounding surfaces defining said opening, said method including the steps of moving said barrier means via hinge means from a closed condition, wherein the opening is closed, to an open condition, wherein the opening is open, releasing said barrier means when in the closed position to allow automatic closure of the barrier means, said hinge means arranged so that the barrier means and/or hinge means has an axis of pivot which is at an acute angle to a vertical axis, resilient biasing means associated with the hinge means to help bias the barrier means from the open condition to the closed condition in use, and the resilient biasing means acting in a direction along a substantially horizontal axis or along an axis substantially transverse or perpendicular to the axis of pivot of the barrier means and/or hinge means.

Embodiments of the present invention will now be described with reference to the accompanying figures, wherein:

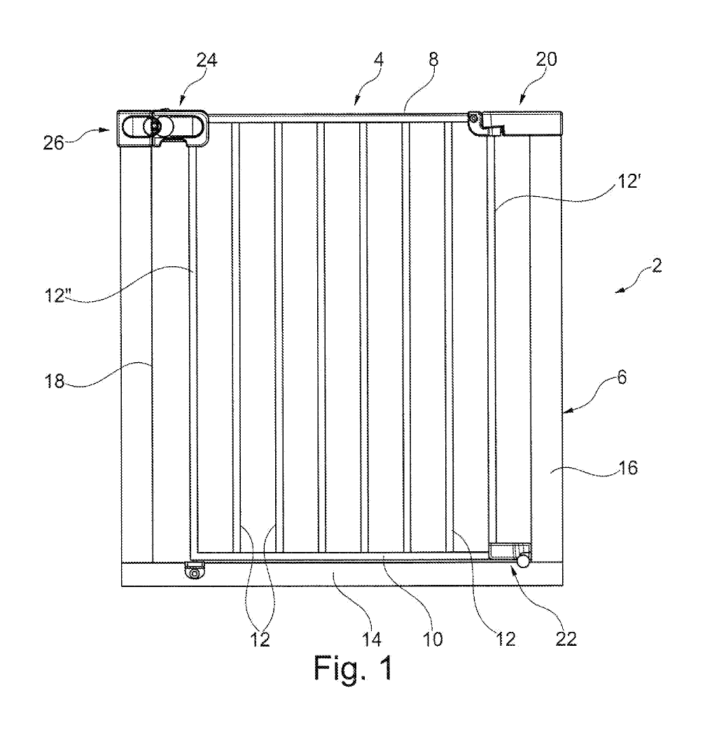

FIG. 1 is a front view of a gate assembly according to an embodiment of the present invention when in a closed condition;

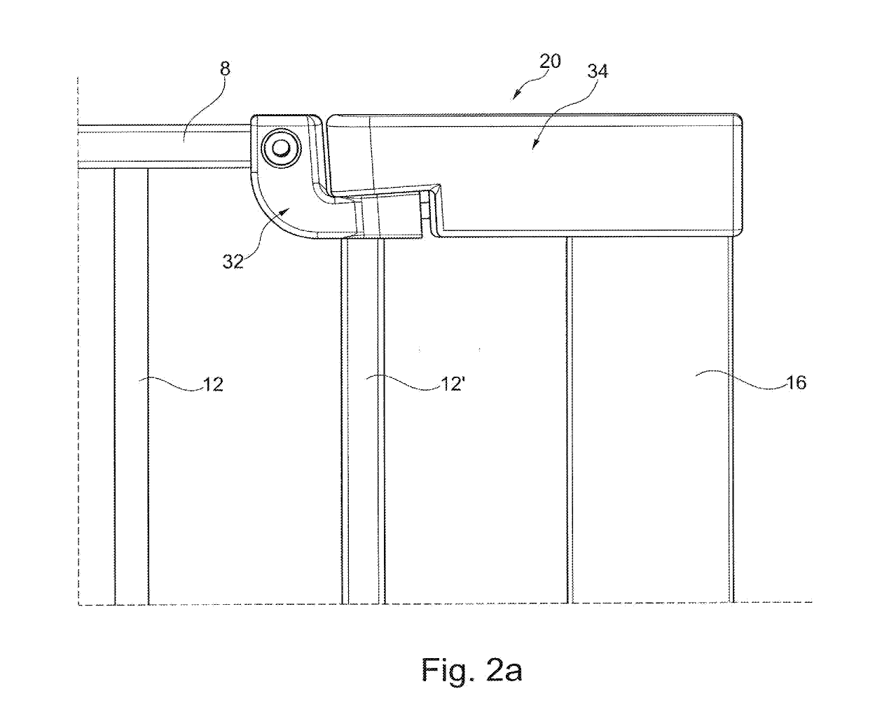

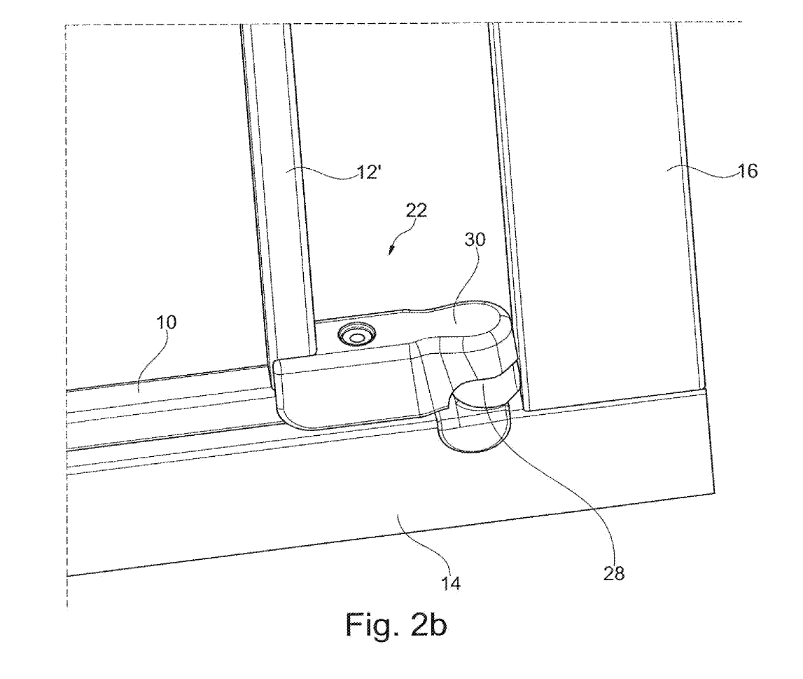

FIGS. 2a and 2b are enlarged views of upper and lower hinge arrangements of the gate assembly in FIG. 1 respectively;

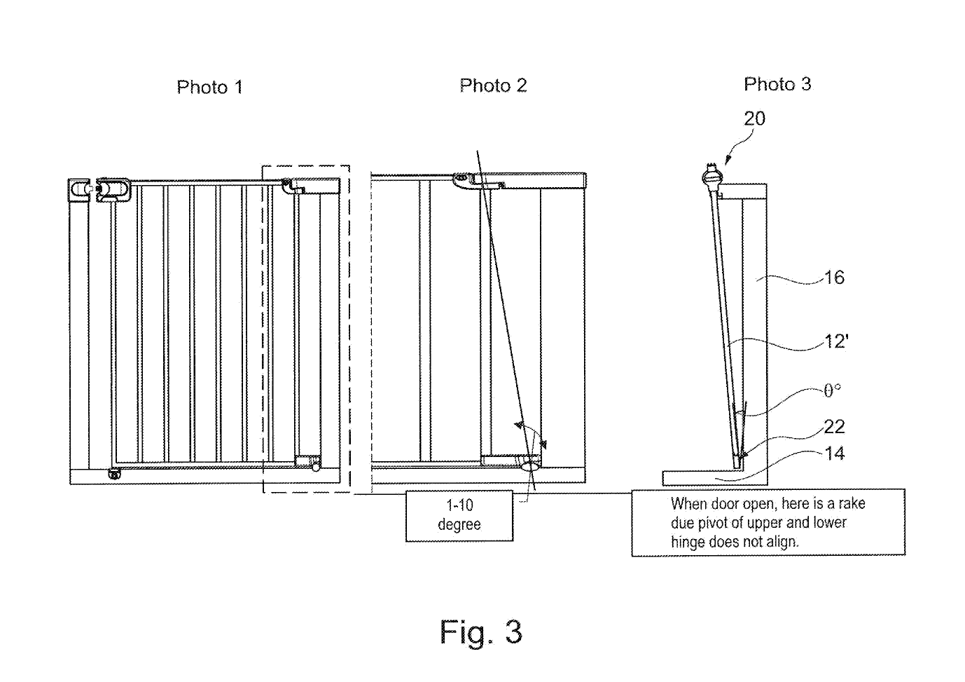

FIG. 3 is a front view of part of the gate assembly in FIG. 1 when in an open condition;

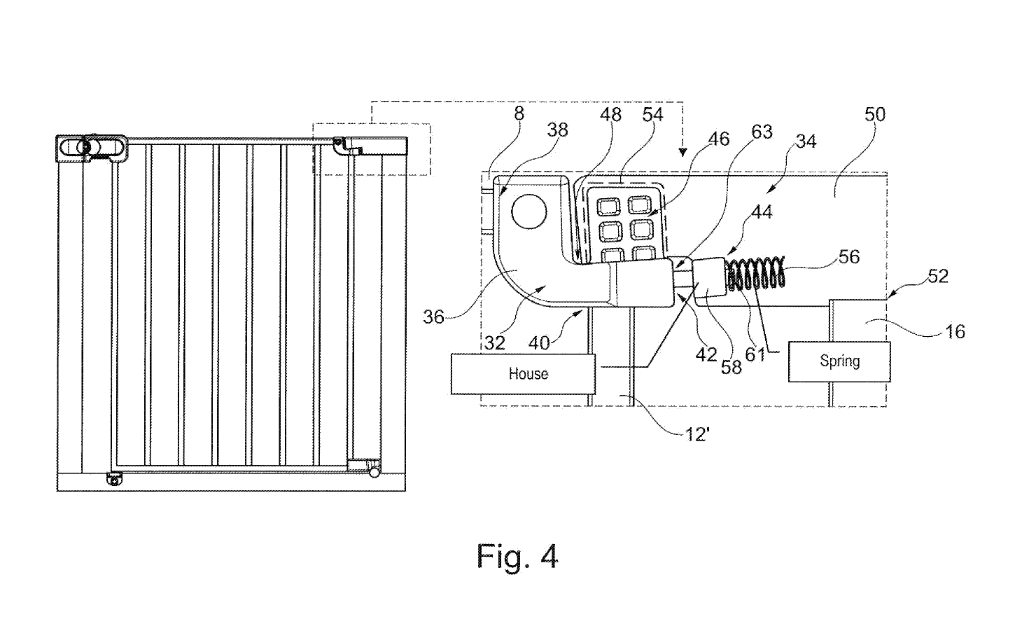

FIG. 4 is an enlarged view of the upper hinge arrangement respectively with part of the outer frame housing removed;

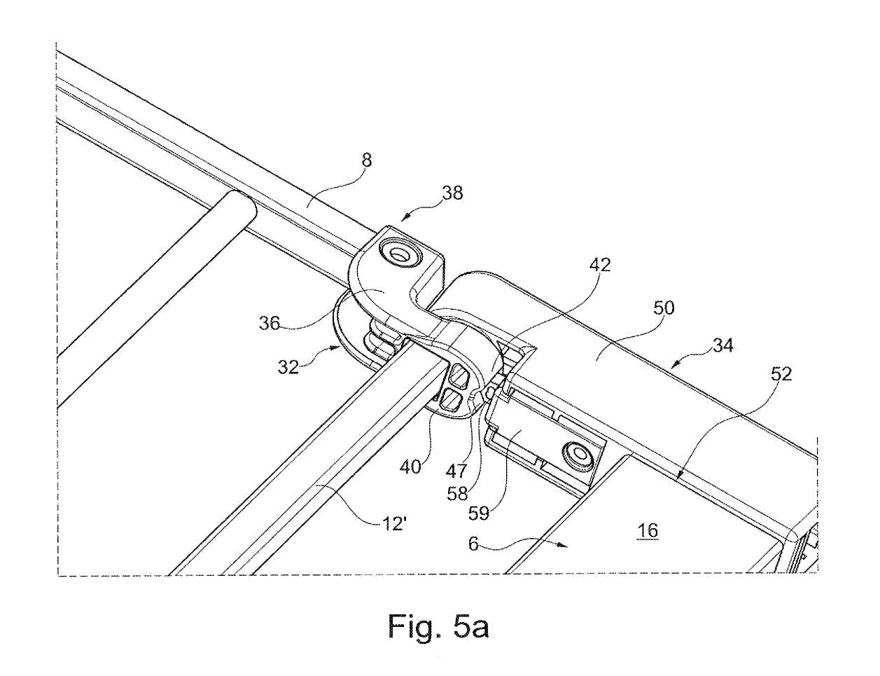

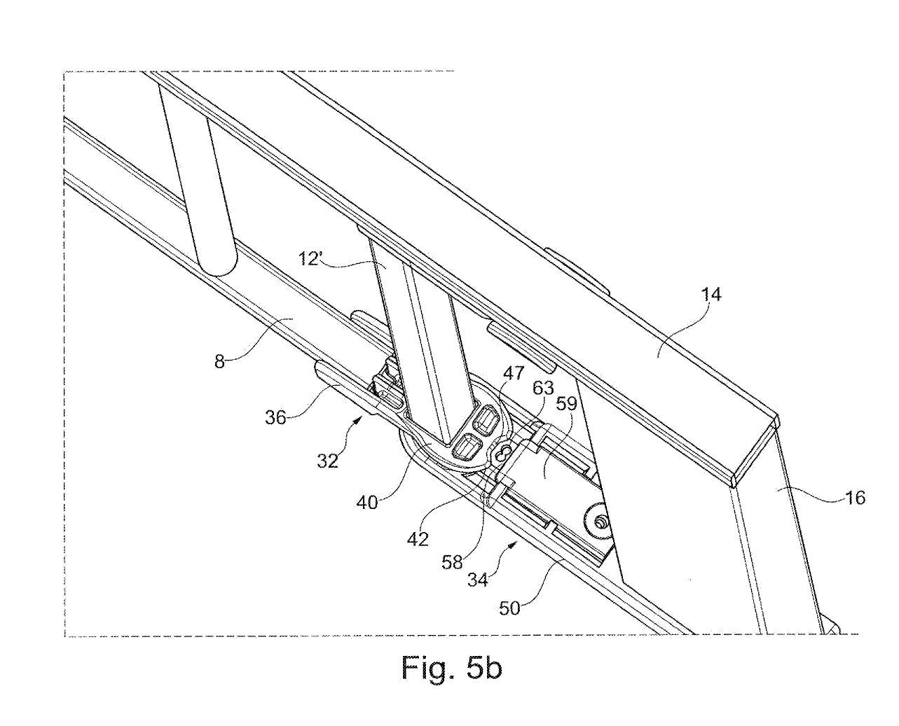

FIGS. 5a-5b show a perspective view of the upper hinge arrangement from below and a plan view of the upper hinge arrangement from below respectively;

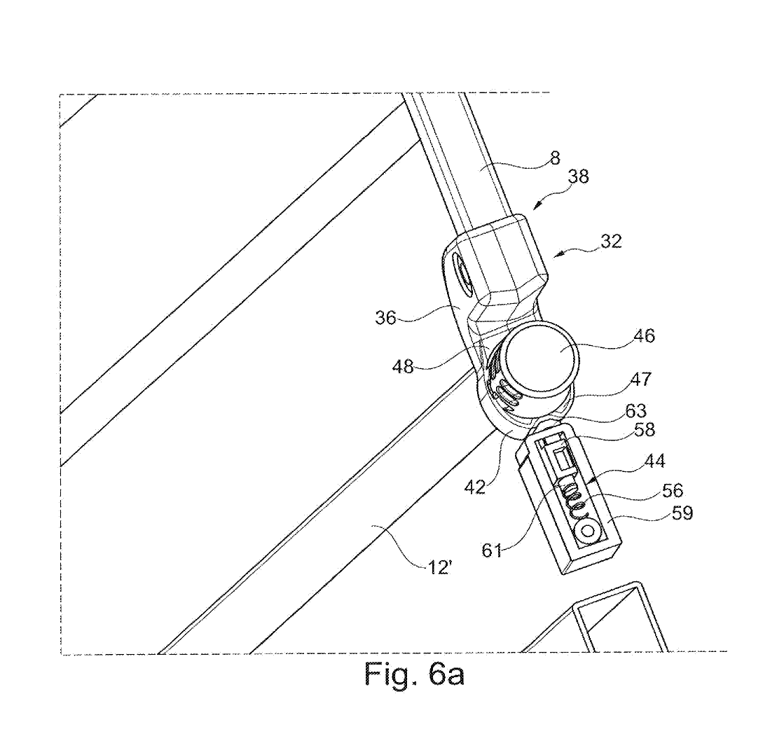

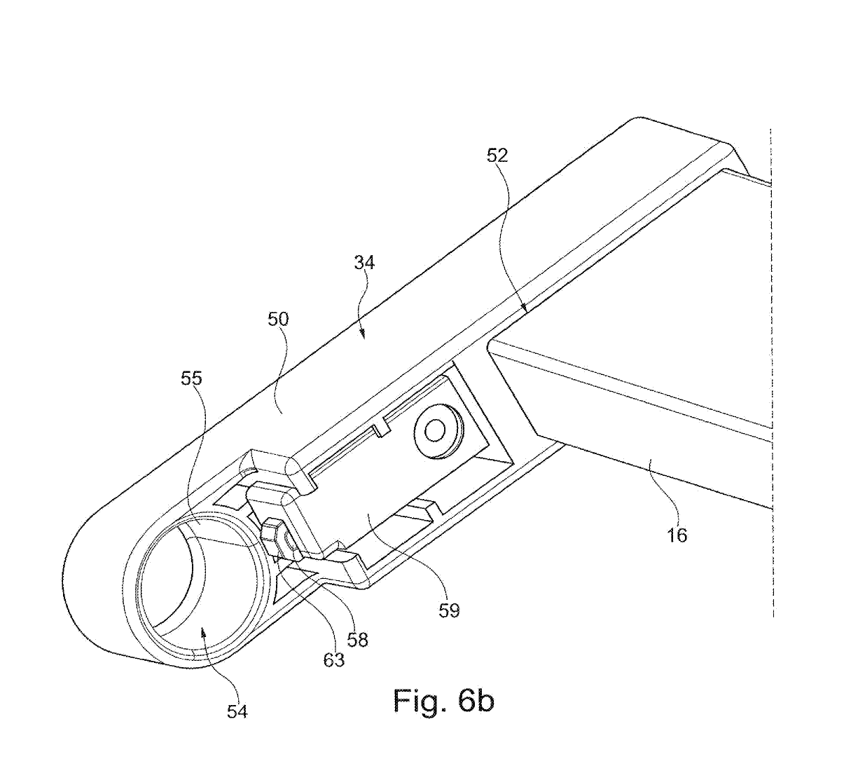

FIGS. 6a and 6b show a perspective view of the upper hinge arrangement with the frame hinge element removed and with the barrier hinge element removes respectively;

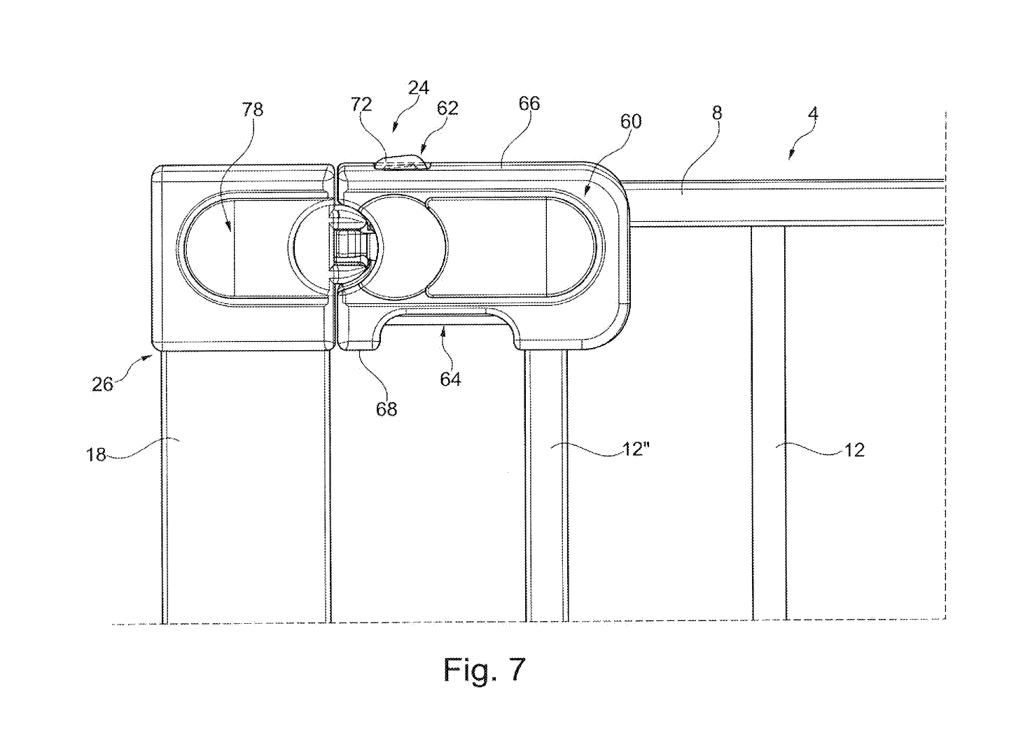

FIG. 7 is an enlarged view of a handle mechanism according to an embodiment of the present invention when in a closed position;

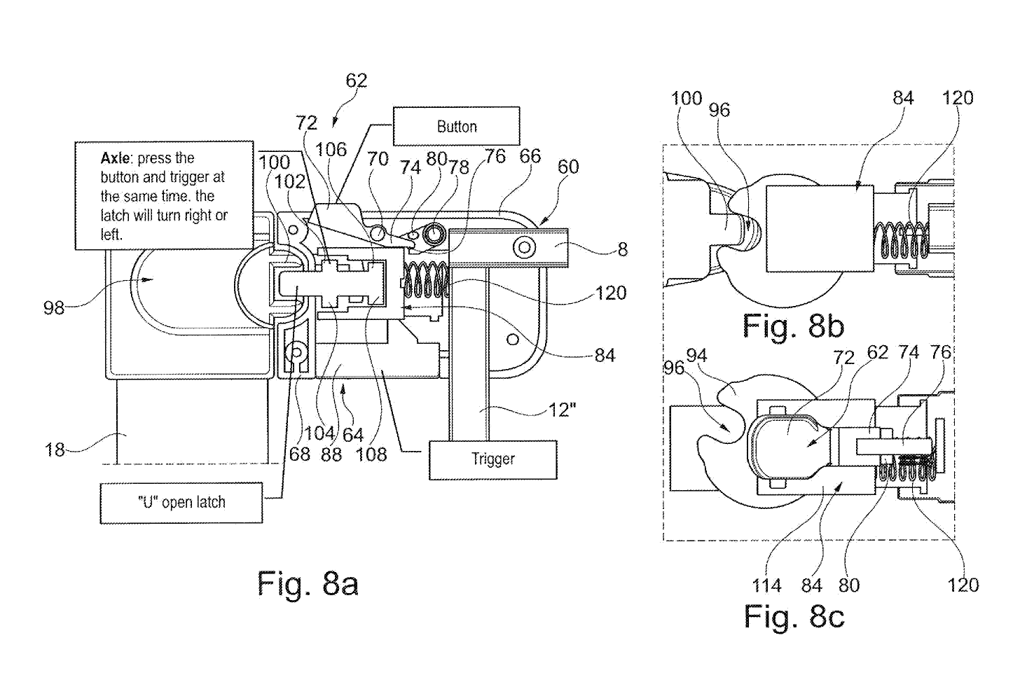

FIGS. 8a-8c show a cross sectional view of the handle mechanism in FIG. 7, a plan view of the handle mechanism in FIG. 7 when in a closed position, and a plan view of the handle mechanism in FIG. 7 when in an open position;

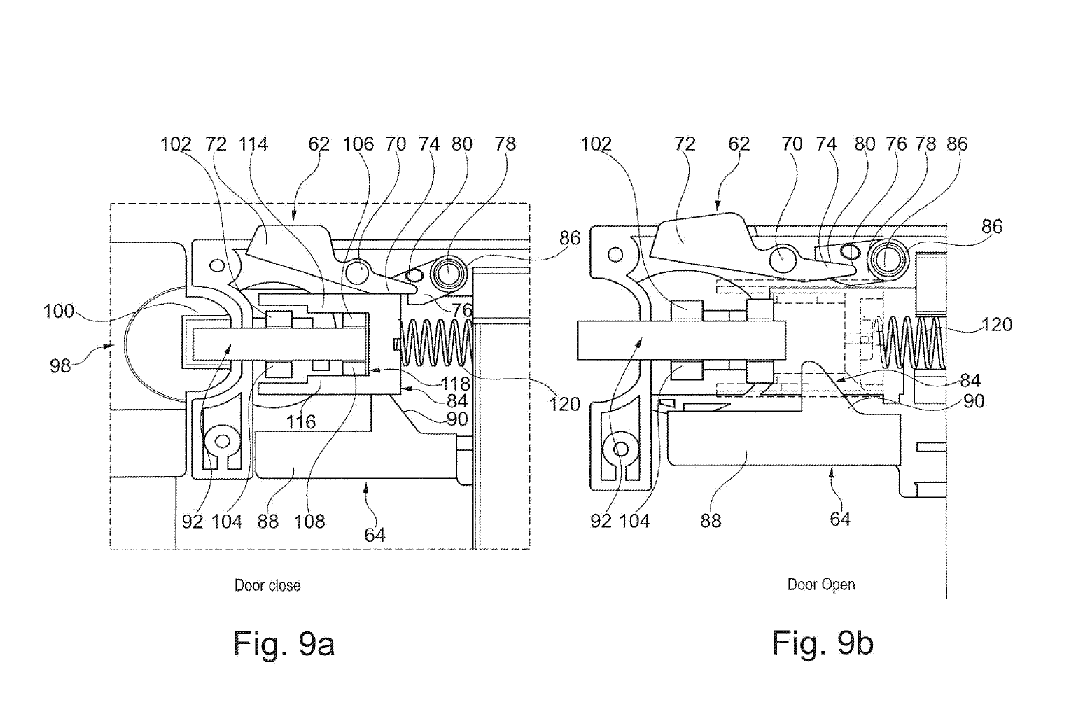

FIGS. 9a and 9b show cross sectional views of the handle mechanism in FIG. 7 in a closed position and in an open position respectively; and

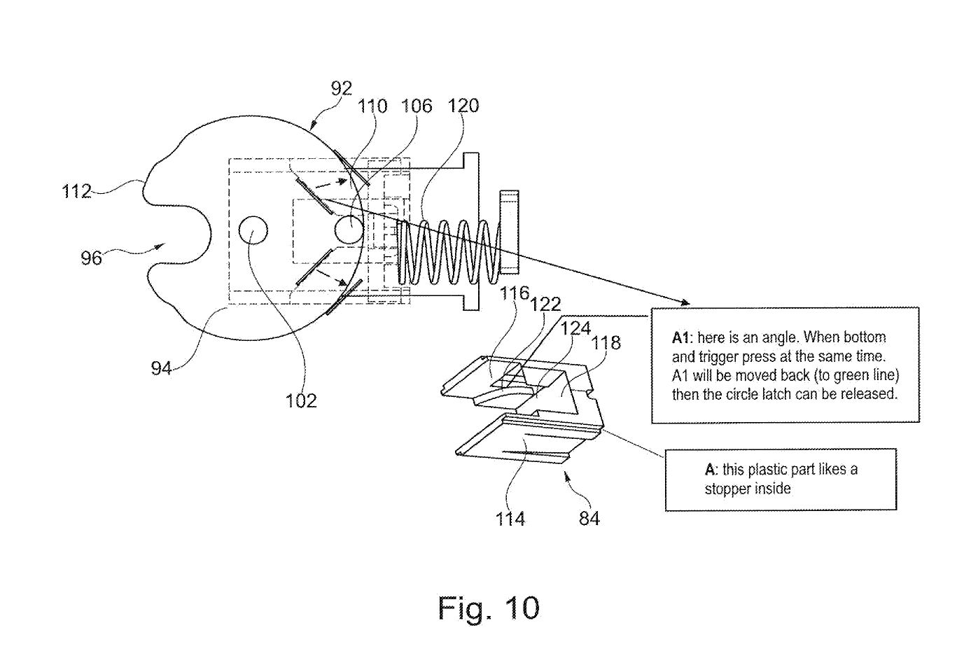

FIG. 10 shows a partial exploded view of the latch means and the locking means of the handle mechanism in FIG. 7.

Referring to FIGS. 1-6b, there is illustrated a gate assembly 2, such as for example a child safety gate, for preventing a child or small animal from passing from one side of the gate to another side of the gate when the gate is in a closed position. The gate assembly 2 is typically mounted in an opening in use through which selective access is required.

The gate assembly 2 includes barrier means 4 pivotably movable with respect to frame means 6 between a closed condition, wherein the opening in which the gate assembly is mounted is closed and access through the gate is substantially prevented, to an open condition, wherein the opening in which the gate assembly is mounted is open and access through the opening is allowed.

The barrier means 4 includes an upper barrier member 8, a lower barrier member 10 and a plurality of upright barrier members 12 located between the upper and lower barrier members 8, 10 to form a barrier.

The frame means 6 includes a base frame member 14, a first upright frame member 16 and a second upright frame member 18. Upper and lower hinge arrangements 20, 22 respectively are provided adjacent first upright frame member 16 to allow for the pivotal movement of the barrier means 4 between the open and closed conditions in use. A handle mechanism 24 is provided adjacent second upright frame member 18 at a top end 26 thereof to allow the gate assembly to be moved between a latched position and an unlatched position, as will be explained in more detail below.

According to a first aspect of the present invention, the gate assembly has an automatic closure mechanism associated therewith, such that when the barrier means is in an open condition and a user releases their grip on the barrier means, the barrier means automatically moves from the open position to the closed position. The barrier means can move from the open position to the closed position even when the gate is in a 1 degree or greater open position (i.e. is open by 1 degree or more with respect to the closed position), as will be described in more detail below.

In accordance with the first aspect of the present invention, the pivot axes of the upper and lower hinge arrangements 20, 22 are provided in an offset position and are provided at an acute angle to the vertical. More particularly, the lower hinge arrangement 22 is provided a spaced distance apart from the pivotal axis of the upper hinge arrangement 20 along a substantially horizontal axis. The lower hinge arrangement 22 is provided closer to first upright frame member 16 than upper hinge arrangement 20.

If an imaginary line were to be drawn between the pivot points and/or along the pivotal axes of both the upper and lower hinges 20, 22, this imaginary line would form an angle θ° with respect to the vertical axis or with respect to upright frame member 16. The angle θ° is typically an angle between 1-10 degrees.

Lower hinge arrangement 22 comprises a lower pivot member 28 joined to base frame member 14 on which is pivotably mounted an upper pivot member 30. At least part of upper pivot member 30 is joined to upright barrier member 12′ adjacent lower barrier member 10. Movement of the barrier means 4 between the open and closed conditions, causes upper pivot member 30 to rotate about lower pivot member 28. The lower pivot member 28 typically includes a pivot pin or protrusion portion which rotatably locates in a complementary shaped recess provided in upper pivot member 30.

Upper hinge arrangement 20 includes a first or lower pivot member 32 associated with the barrier means 4 and an upper or second pivot member 34 associated with frame 6. Lower pivot member 32 comprises a body portion 36 having a first end portion 38 joined to upper barrier member 8, a base surface 40 joined to upright barrier member 12′ and a second end portion 42 which abuts with resilient biasing means 44 associated with the upper pivot member 34. A pivot pin 46 is provided on a top surface 48 of lower pivot member 32 and protrudes upwardly/outwardly therefrom. A curved recess 47 is defined in second end portion 42 for engagement with the resilient biasing means therewith in use.

Upper pivot member 34 of the upper hinge arrangement 20 comprises a housing 50 which is joined to a top end 52 of first upright frame member 16. A recess 54 is defined in housing 50, with an opening defined in a base surface 55 of housing 50 for the location and pivotal movement of pivot pin 46 of the lower pivot member 32 therein in use.

The resilient biasing mechanism 44 helps to bias the barrier means to a closed position, thereby allowing the barrier means 4 to automatically move from an open position to a closed position when a user releases their grip on the barrier means 4 in use. Resilient biasing mechanism 44 includes an intermediate member 58 that is slidably mounted in a spring housing 59. Spring housing 59 is attached within a suitably shaped recess in housing 50. A first end 61 of intermediate member 58 is joined to resilient biasing means in the form of a spring 56, and a second end 63 of intermediate member 58 is provided in engagement with curved recess 47 of second end portion 42 of the lower pivot member 32. The second end 63 of intermediate member 58 is substantially complementary in shape to the curved recess 47.

In use, second end 63 of intermediate member 58 is located in recess 47 of lower pivot member 32 when the gate is in a closed position. The intermediate member 58 is in a relatively extended position with respect to the spring housing 59, and spring 56 is in a relatively tensioned position. As the barrier means 4 is moved from the closed position to the open position, the curved side walls of recess 47 pivot and slidingly moves intermediate member 58 inwardly of spring housing 59 to a relatively recessed position, thereby compressing spring 56. As the gate moves from the open position to the closed position, the side walls of recess 47 pivot away from spring housing 59 and the biasing force of spring 56 pushes the intermediate member 58 outwardly of the spring housing 59, helping the automatic closure of the barrier means to the closed position.

The spring 56 and intermediate member 58 typically move in a substantially horizontal direction or transverse direction with respect to the pivot axis of the gate hinges when moving between compressed and tensioned conditions corresponding to the open and closed positions of the barrier means respectively.

Due to the offset nature of the upper and lower hinge arrangements 20, 22, the inclined nature of the pivotal axis of the hinge arrangements, the provision of the resilient biasing means 44 and the weight/gravitational force acting on the barrier means, the barrier means can automatically move from an open position to a closed position, even when the barrier means is only slightly open (i.e. at an open position of 1 degree with respect to the closed gate position). On movement of the barrier means 4 from the closed position to the open position, rotation of the upper and lower hinge arrangements about their pivot axes causes barrier means 4 to move from a closed condition, wherein the barrier means 4 is substantially in the same plane as the frame means 6 and upright barrier members 12, 12′, 12″ are substantially parallel to upright frame member 16, to an open condition, wherein the barrier means 4 is at an acute angle θ° to the vertical and/or horizontal axis or to the upright frame member 16.

Referring to FIGS. 7-10, there is illustrated a handle mechanism 24 for use on gate assembly 2 in one embodiment. It will be appreciated that the handle mechanism could be used independently of the hinge arrangement described in the first embodiment if required or could be used together therewith. The handle mechanism provides an improved latching arrangement during automatic closure of the gate assembly as will be described in more detail below.

The handle mechanism 24 includes a housing 60 in which first and second user actuation means 62, 64 are provided on a top surface 66 and a base surface 68 of the housing 60 respectively.

First user actuation means 62 is in the form of a button member which is pivotably mounted for pivotal movement about pivot pin 70. Depression of button 62 inwardly or downwardly of housing 60 at end 72 causes the opposite end 74 to move upwardly or against a stop member 76. Stop member 76 is pivotably mounted for pivotal movement about pivot point 78. In particular, a protrusion member 80 is provided on stop member 76 and end 74 of button 62 moves against member 80 on actuation of button 62 to pivot stop member 76 from an engaged position, wherein end 82 of stop member 76 engages with locking means 84, and a disengaged position, wherein end 82 of stop member 76 is disengaged from locking means 84. Resilient biasing means in the form of a spring 86 is associated with stop member 76 to bias the stop member to an engaged position on release of the first user actuation means.

Second user actuation means 64 is in the form of a trigger member 88 which is slidably mounted in housing 60. Depression of trigger member 88 inwardly or upwardly of housing 62 causes a cam surface 90 provided on an upper part of trigger member 88 to move relative to locking means 84. More particularly, cam surface is provided on a protrusion which has a narrowing taper towards a free end thereof. Upwardly movement of cam surface 90 relative to the locking means 84 causes the locking means 84 to slidably move from a locked position, as shown in FIGS. 8a and 9a, to an unlocked position, as shown in FIG. 9b. Thus, substantially vertical movement of the trigger member 88 causes substantially horizontal movement of the locking means 84.

The handle mechanism further includes latch means 92 having a body portion 94 with a substantially U-shaped recess 96 adjacent an outer edge thereof. Latch receiving means 98 includes a latch protrusion 100 which locates in latch recess 96 when the handle mechanism is in a latched position, as shown in FIGS. 7, 8a, 8b and 9a.

The latch receiving means 98 is typically located at top end 26 of upright frame member 18. The handle mechanism housing 60 is typically joined to upper barrier member 8 and upright barrier member 12″.

The latch means 92 is pivotably mounted for pivotal movement about upper and lower pivot pins 102, 104 respectively. The upper and lower pivot pins 102, 104 are provided substantially centrally on upper and lower surfaces of body portion 94 respectively. Pivotal movement of latch means 92 is typically about a substantially vertical axis. Locking protrusions 106, 108 are also provided on upper and lower surfaces of body portion 94 towards an edge 110 of body portion 94 substantially opposite the edge 112 with recess 96 defined therein. The locking protrusions 106, 108 engage with locking means 84 when in a locked position, thereby preventing rotation of latch means 92 until the locking means 84 are moved to an unlocked position.

The locking means 84 is substantially U-shaped in form having a top surface 114, a base surface 116 and an end surface 118. The locking means 84 is slidably movable between a locked position, wherein it substantially prevents rotation of latch means 92, and an unlocked position, wherein rotation of latch means 92 can take place. The sliding movement of the locking means 84 is typically in a substantially horizontal direction or substantially transverse to the pivotal axis of latch means 92.

Resilient biasing means in the form of a spring 120 biases the locking means 84 to the locked position in use, thereby also biasing the trigger member 88 to an unactuated position.

A slot 122 is defined in base surface 116 of the locking means 84 to allow cam surface 90 to be located therethrough on actuation of the trigger member 88 in use. In addition, locking protrusion receiving slots 124 are defined adjacent top surface 114 and base surface 116 for receiving locking protrusions 106, 108 of the latch means 92 respectively in use when in the locked position. The locking protrusion receiving slots 124 are typically slots, the opening of which has a narrowing taper towards end surface 118 to allow engagement of the locking protrusions 106, 108 therein.

In use of the handle mechanism, with the gate assembly in a closed position and the latch means 92 in a latched position, the latch recess 96 of the handle mechanism is engaged with the latch protrusion 100 of the latch receiving means 98 provided on the frame means 6. In order for a user to move the gate assembly from a closed position to an open position, the user must first actuate the first and second user actuation means of the handle mechanism at the same time to unlatch the handle mechanism. Thus, a user is required to depress button 62 and trigger member 88 substantially simultaneously.

Actuation of button 62 causes end 74 to pivot upwardly against stop member 76, thereby pivoting stop member 76 from an engaged position to a disengaged position with respect to locking means 84. Actuation of trigger member 88 causes cam surface 90 to move upwardly through slot 122 of locking means, which in turn causes the locking means to slidably move backwards in the housing away from the latch means 92 against the resilient biasing force of spring 120. Movement of the locking means 84 in this manner causes the locking means to move from a locked position, wherein the locking protrusions 106, 108 of the latch means are retained in the locking protrusion receiving slots 124, to an unlocked position, wherein the locking protrusions 106, 108 of the latch means are a spaced distance from the locking protrusion receiving slots 124.

With the locking means 84 in an unlocked position, the latch means can now be moved from the latched position to an unlatched position. This is achieved by the user maintaining actuation of the first and second user actuation means and moving the barrier means 4 towards or away from them or relative to the latch receiving means from a closed position to an open position. Movement of the handle means relative to the latch receiving means causes latch means 92 to pivot about pivot pins 102, 104, thereby moving latch recess 96 out of engagement with latch protrusion 100 of the latch receiving means 98.

The latch means 92 can be pivotably rotated in either a clockwise direction or an anticlockwise direction depending on the direction the user moves the gate relative to the latch receiving means. For example, if the user moves the gate in an anti-clockwise direction, the latch means pivots in a clockwise direction. If the user moves the gate in a clockwise direction, the latch means pivots in an anti-clockwise direction.

Once the user releases their grip on the handle mechanism, the gate typically automatically closes using a suitable autoclosure mechanism associated with the hinge arrangement or elsewhere. The first user actuation button 62 is biased to an unactuated position as a result of the biasing force on stop member 76 caused by spring 86 moving the stop member 76 to an engaged position with the end surface of locking means 84. The locking means is moved towards latch means 92 under the biasing force of spring 120, thereby causing the second user actuation trigger member 88 to move to an unactuated position. Latch means 92 is moved from an unlocked position towards a locked position. Once the gate is nearly closed, edge 112 of the latch means 92 engages against the latch protrusion 100 of latch receiving means 98, thereby forcing the locking protrusions 106, 108 on the latch means into firm engagement with the locking protrusion receiving slots 124 on the locking means. This locks the latch means 92 into the locked position and engages the latch protrusion 100 in the latch recess 96, thereby re-latching the gate.

The provision of the latching means which is pivotably or rotatably movable following actuation of the user actuation means on movement of the handle mechanism relative to latch receiving means, helps the automatic closure mechanism of the gate assembly close over a much smaller angle of opening (i.e. when the gate is only open approximately 1 degree relative to the closed position).

1. A gate assembly for positioning in an opening through which selective entry is required, said gate assembly including barrier means mountable directly or indirectly to one or more surrounding surfaces defining said opening and hinge means to allow said barrier means to be movable relative to said surrounding surfaces in use between a closed condition, wherein the opening is closed, to an open condition, wherein the opening is open, said hinge means arranged so that the barrier means and/or hinge means has an axis of pivot which is at an acute angle to a vertical axis, resilient biasing means associated with the hinge means to help bias the barrier means from the open condition to the closed condition in use, characterised in that the resilient biasing means act in a direction along a substantially horizontal axis or along an axis substantially transverse or perpendicular to the axis of pivot of the barrier means and/or hinge means.

2. A gate assembly according to claim 1 wherein the gate assembly automatically moves from an open position to a closed position once a user release their grip on the barrier means in use.

3. A gate assembly according to claim 1 wherein the hinge means includes an upper hinge arrangement provided at, adjacent or towards a top of the barrier means, a lower hinge arrangement provided at, adjacent or towards a base of the barrier means and the axis of pivot of the upper and lower hinge arrangements is at an acute angle to the vertical axis.

4. A gate assembly according to claim 1 wherein the acute angle is between 1-10 degrees.

5. A gate assembly according to claim 3 wherein the resilient biasing means is provided with or associated with at least the upper hinge arrangement.

6. A gate assembly according to claim 1 wherein the resilient biasing means and/or an intermediate member is provided with or associated with a frame element or wall to which the hinge means or at least part of an upper hinge arrangement is pivotably mounted to in use.

7. A gate assembly according to claim 6 wherein the intermediate member is slidably mounted in a housing associated with the frame element or wall and has a first end in engagement with the barrier means, hinge means or upper hinge arrangement and a second end in engagement with the resilient biasing means.

8. A gate assembly according to claim 7 wherein the first end of the intermediate member is curved, angled, bevelled, chamfered and/or is a cam surface.

9. A gate assembly according to claim 7 wherein the first end of the intermediate member engages in a slot, recess or channel defined in the barrier means, hinge means or upper hinge arrangement.

10. A gate assembly according to claim 7 wherein the resilient biasing means biases the intermediate member towards the barrier means and pivotal movement of the barrier means in use causes sliding movement of the intermediate member against a biasing force of the resilient biasing means.

11. A gate assembly according to claim 7 wherein the upper hinge arrangement has a first hinge element including a pivot pin or protrusion member which is pivotally or rotatably mounted in a recess, channel or aperture provided on a second hinge element including a recess, the first end of the intermediate engaging with an outer surface of the first hinge element.

12. A gate assembly according to claim 1 wherein a handle mechanism is provided on the gate assembly, said handle mechanism including latch means movable with respect to latch receiving means between a latched position, wherein the latch means is engaged with or located in the latch receiving means, and an unlatched position, wherein the latch means is disengaged from or removed from the latch receiving means, and user actuation means for allowing a user to actuate said latch means in use, and wherein actuation of said user actuation means enables said latch means to undergo movement on movement of the handle mechanism, barrier means or gate assembly relative to the latch receiving means.

13. A gate assembly according to claim 12 wherein the latch means is arranged to undergo rotational and/or pivotal movement on movement of the handle mechanism, barrier means or gate assembly relative to the latch receiving means.

14. A gate assembly according to claim 12 wherein locking means are associated with the latch means and actuation of the user actuation means moves the locking means from a locked position, wherein movement of the latch means is substantially prevented, to an unlocked position, wherein movement of the latch means is enabled.

15. A method of using a gate assembly for positioning in an opening through which selective entry is required, said gate assembly including barrier means mountable directly or indirectly to one or more surrounding surfaces defining said opening, said method including the steps of moving said barrier means via hinge means from a closed condition, wherein the opening is closed, to an open condition, wherein the opening is open, releasing said barrier means when in the closed position to allow automatic closure of the barrier means, said hinge means arranged so that the barrier means and/or hinge means has an axis of pivot which is at an acute angle to a vertical axis, resilient biasing means associated with the hinge means to help bias the barrier means from the open condition to the closed condition in use, and the resilient biasing means acting in a direction along a substantially horizontal axis or along an axis substantially transverse or perpendicular to the axis of pivot of the barrier means and/or hinge means.
